(19) United States
(12) Patent Application Publication
(10) Pub. No.: US 2007/0261312 A1
(43) Pub. Date: Nov. 15, 2007

(54) Smoke proof door jamb

(76) Inventor: Peter Kuppler, Howell, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 11/431,053

(22) Filed: May 9, 2006

(51) Int. Cl. E06B 1/70

(52) U.S. Cl. 49/470

(57) ABSTRACT

A smoke proof door jamb is disclosed for sealing the door against the ingress of smoke from a fire external to the room. In addition, the door jamb also has an identification sticker attached thereto so that firefighters can locate a particular room during a fire.

### BACKGROUND OF THE INVENTION

The present invention is directed to the field of safety devices to be installed in a home or other building to make the home or building safer in case of a fire. During a fire, especially in a home, it is oftentimes crucial for firefighters to be able to quickly identify locations such as a child's bedroom. If the firefighter can do so, the bedroom can be searched and any necessary rescue of the child can be quickly effectuated prior to the fire spreading to the room where the child may be located. The presently available devices for locating such locations are window stickers or other means which oftentimes are not transportable when a child changes rooms or which may fade or fall off the window.

A significant risk during a fire in a home is that a person may be trapped in a bedroom at night when a fire breaks out in another room of the home. When that occurs, the person may have trouble keeping the smoke from the fire out of the room while awaiting rescue by firefighters.

The object of the present invention is to provide a simple device that solves both of the aforementioned problems. Thus, the present invention is directed to a device which prevents smoke from entering a room and can also be used to identify a child's bedroom or other area of the building that the firefighter would want to quickly locate.

### SUMMARY OF THE INVENTION

The present invention is directed to a fire safety device for installation on a door of a room comprising a sealing device adapted to be removeably installed on the bottom of the door to prevent the ingress of smoke into the room and as an identification means attached to the sealing device.

### BRIEF DESCRIPTION OF THE DRAWINGS

FIG. 1 is a front plan view of an embodiment of the present invention.

FIG. 2 is a front view of an embodiment of the present invention as installed on the bottom of a door.

FIG. 3 is a back view of an embodiment of the present invention as installed on the bottom of a door.

FIG. 4 is a side view of an embodiment of the present invention as installed on the bottom of a door.

### DETAILED DESCRIPTION OF THE INVENTION

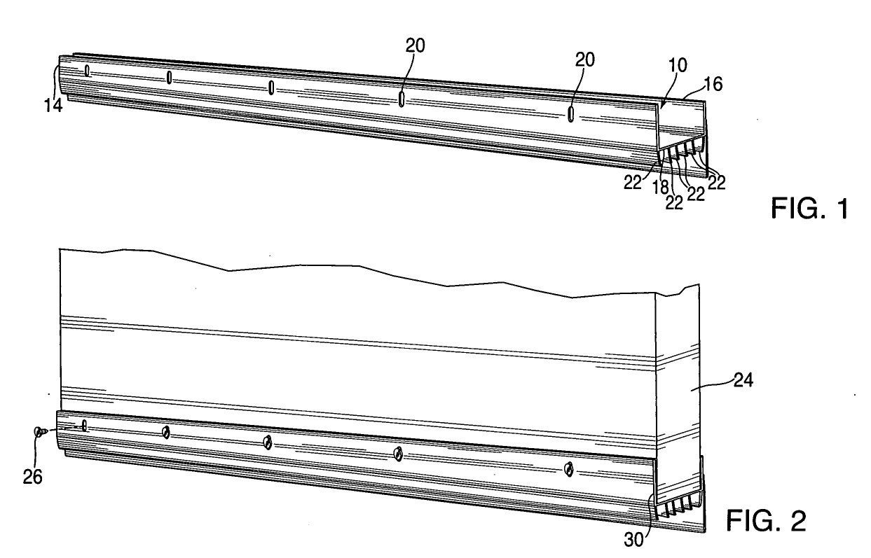

The present invention will now be described in terms of the presently preferred embodiment thereof. The present invention is directed to a smoke proof door jamb 10 as illustrated in the Figures. The doorjamb 10 comprises a generally rectangular channel 12 that is open at the top. The rectangular channel 12 comprises side walls 14 and 16 and a bottom wall 18. Side wall 14 comprises a plurality of slots 20. Side wall 16 also extends below the bottom wall 18 as shown in FIG. 1. The door jamb 10 further comprises a plurality of flexible projections 22 that project downward from the bottom wall 18 and are generally parallel to the side walls 14 and 16. A light reflecting sticker 28 will be affixed to the front surface 30 to identify the room as being a child's bedroom for example.

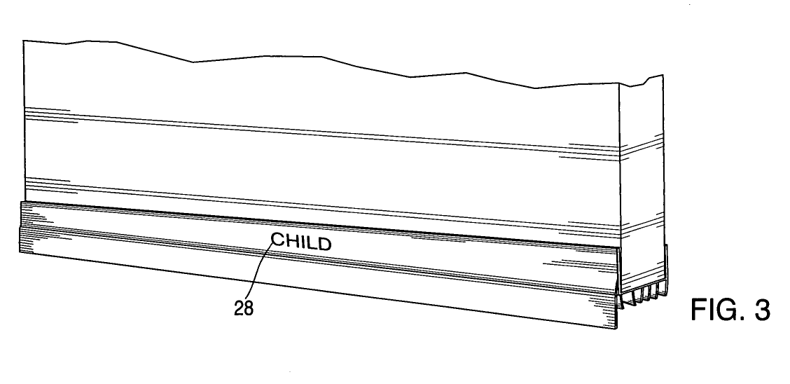

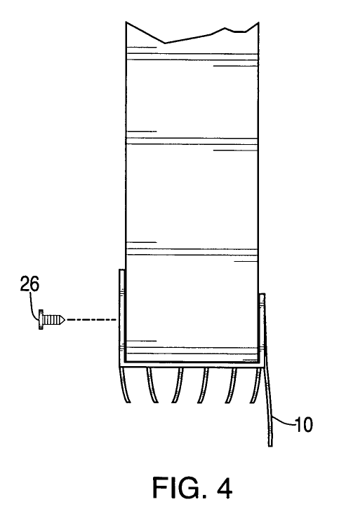

The installation and use of the door jamb 10 is illustrated in FIGS. 2, 3 and 4. As shown in FIG. 2, the rectangular channel 12 is adapted to be slidingly installed on the bottom of a door 24. A plurality of screws 26 or other similar fastening devices are mounted through the plurality of slots 20 to secure the door jamb 10 to the bottom of the door.

It is contemplated that the door jamb 10 and its associated components will be fabricated from a material that is somewhat flexible or elastic such as an appropriate plastic. In this way the exterior of side wall 16 as well as the plurality of projections 22 will act to seal the bottom of the door to the floor surface and prevent the ingress of smoke into the room.

The doorjamb 10 can also be removed from the door by removing the plurality of screws. Then, the door jamb 10 could be reinstalled on another door in the home if the child's bedroom is changed.

Those of ordinary skill in the act will recognize that the foregoing merely describes one embodiment of the present invention and many obvious modifications may be made thereto without departing from the spirit or scope of the present invention as set forth in the appended claims.

What is claimed is:

1. A fire safety device for installation on a door of a room comprising:
a) A sealing device adapted to be removeably installed on the bottom of the door to prevent the ingress of smoke into the room; and
b) An identification means attached to the sealing device.

2. The fire safety device of claim 1 where the sealing device comprises a generally rectangular, elongated channel adapted to fit on the bottom of the door and a plurality of flexible elongated projections that project from the bottom of the rectangular channel.
